(19) United States
(12) Patent Application Publication
(10) Pub. No.: US 2022/0300706 A1
(43) Pub. Date: Sep. 22, 2022

(54) INFORMATION PROCESSING DEVICE AND METHOD OF MACHINE LEARNING

(71) Applicant: FUJITSU LIMITED, Kawasaki-shi (JP)

(72) Inventor: Chunpeng MA, Kawasaki (JP)

(73) Assignee: FUJITSU LIMITED, Kawasaki-shi (JP)

(21) Appl. No.: 17/693,438

(22) Filed: Mar. 14, 2022

(30) Foreign Application Priority Data
Mar. 19, 2021 (JP) 2021-046407

(51) Int. Cl. G06F 40/20; G06N 20/00

(52) U.S. Cl. CPC G06F 40/20; G06N 20/00

(57) ABSTRACT

A non-transitory computer-readable recording medium stores a program that causes a computer to execute a process, the process includes acquiring a plurality of pieces of training data that include passage data, a question sentence, and an output value, and training a first model so that first derivation information output from the first model approaches to second derivation information output from a second model, the first model being configured to output a first output value and the first derivation information when first passage data and a first question sentence are input, the first derivation information indicating a method of deriving the first output value from the first passage data, the second model being configured to output the second derivation information when the first passage data and a second output value are input, the second derivation information indicating a method of deriving the second output value from the first passage data.

### CROSS-REFERENCE TO RELATED APPLICATION

This application is based upon and claims the benefit of priority of the prior Japanese Patent Application No. 2021-046407, filed on Mar. 19, 2021, the entire contents of which are incorporated herein by reference.

### FIELD

The embodiment discussed herein is related to a machine learning technique.

### BACKGROUND

In recent years, a natural language processing model using a neural network has been known, and for example, used for machine translating and reading comprehension.

FIGS. 7 and 8 are diagrams for explaining a typical natural language processing method. FIG. 7 illustrates a functional configuration thereof, and FIG. 8 illustrates processing thereof.

FIG. 7 illustrates an outline of processing by a neural symbolic reader (NeRd). The NeRd includes a reader (READER) and a programmer (PROGRAMMER) and infers an answer (ANSWER) to a question sentence (QUESTION) regarding a passage (PASSAGE) written in a natural language.

Text is input to the reader, and a vectorized expression is output. In the example illustrated in FIG. 8, a passage describing about American football and a question sentence “How many yards was the shortest touchdown pass?” are input to the reader, and values “0.31, 0.56, −0.11, 0.97, −0.99, 0.03, . . . ” are output.

The output (expression) of the reader is input to the programmer. The programmer converts the input expression into an instruction sequence of a program. This instruction sequence may be referred to as a program. In the example illustrated in FIG. 8, a program “MIN (VALUE (17), VALUE (18))” is generated.

Then, by executing this program, an answer to the question is obtained. In the example illustrated in FIG. 8, “1” is output by executing the program “MIN (VALUE (17), VALUE (18))”.

The NeRd may achieve the natural language processing with a simple model structure, and may express an inference process as a program (instruction sequence).

Japanese Laid-open Patent Publication No. 2020-46888, International Publication Pamphlet No. WO 2019/182059, and Dheeru Dua et al., “DROP: A Reading Comprehension Benchmark Requiring Discrete Reasoning Over Paragraphs” 2019, arXiv: 1903.00161v2 Cornell University, 2019 are disclosed as related art.

### SUMMARY

According to an aspect of the embodiment, a non-transitory computer-readable recording medium stores a program that causes a computer to execute a process, the process includes acquiring a training dataset that includes a plurality of pieces of training data in which passage data, a question sentence related to the passage data, and an output value that is an answer to the question sentence are associated one another, and training a first model using the training dataset so that first derivation information output from the first model approaches to second derivation information output from a second model, the first model being configured to output a first output value and the first derivation information when first passage data and a first question sentence are input, the first output value corresponding to the first question sentence, the first derivation information indicating a method of deriving the first output value from first information included in the first passage data, the second model being configured to output the second derivation information when the first passage data and a second output value are input, the second derivation information indicating a method of deriving the second output value from the first information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of an information processing device according to an embodiment;

FIG. 2 is a diagram illustrating an example of an NLP data group in the information processing device according to the embodiment;

FIG. 3 is a diagram for explaining processing of a PS model training unit of the information processing device according to the embodiment;

FIG. 4 is a diagram for explaining processing of an NLP model training unit of the information processing device according to the embodiment;

FIG. 5 is a flowchart for explaining processing of the information processing device according to the embodiment;

FIG. 6 is a diagram illustrating a hardware configuration of the information processing device according to the embodiment;

FIG. 7 is a diagram for explaining a typical natural language processing method; and

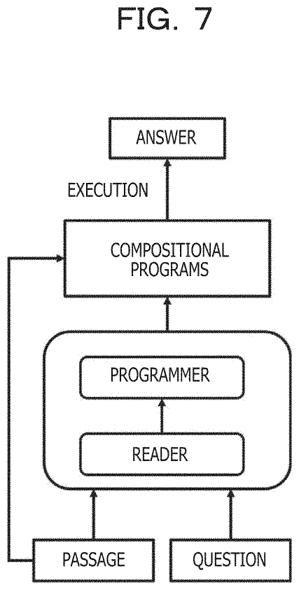

FIG. 8 is a diagram for explaining a typical natural language processing method.

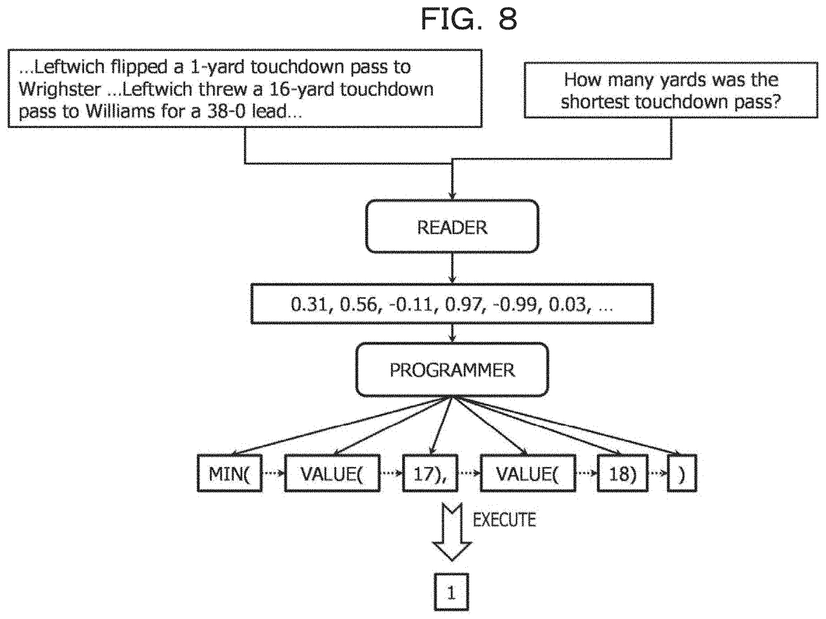

### DESCRIPTION OF EMBODIMENT

In such a typical natural language processing method as described above, the program output from the programmer is treated as a correct answer if the program outputs a value that matches a numerical value of the output and is exemplified a correct answer example. Therefore, there is a problem in that a program with very low versatility and a program which accidentally outputs a correct answer are included in correct answers as noise, and thus accuracy is deteriorated.

Hereinafter, an embodiment will be described with reference to the drawings. Note that the embodiment to be described below is merely examples, and there is no intention to exclude application of various modifications and technologies not explicitly described in the embodiment. In other words, for example, the present embodiment may be variously modified and implemented without departing from the scope of the gist thereof. Furthermore, each drawing is not intended to include only components illustrated in the drawings and may include another function and the like.

(A) Configuration

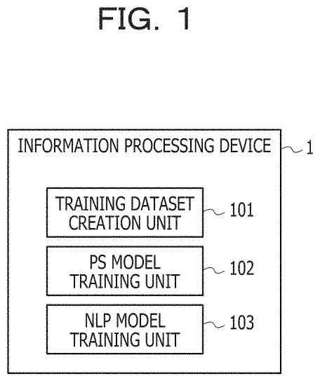

FIG. 1 is a diagram illustrating a functional configuration of an information processing device 1 according to the embodiment.

The information processing device 1 generates a natural language processing (NLP) model that is a machine learning model that executes processing on a document written in a natural language.

As illustrated in FIG. 1, the information processing device 1 includes a training dataset creation unit 101, a program synthesis (PS) model training unit 102, and an NLP model training unit 103.

The training dataset creation unit 101 creates a first training dataset used when the PS model training unit 102 described later trains a PS model and a second training dataset used when the NLP model training unit 103 described later trains an NLP model.

The first training dataset includes a plurality of pieces of first training data. The first training data includes input text, an application instruction sequence, and an application result.

The input text is a text sentence described in a natural language. For example, the training dataset creation unit 101 may create input text by randomly extracting a passage having a length equal to or longer than a predetermined length from a known unlabeled corpus (for example, document database or long text sentence).

It is assumed that the training dataset creation unit 101 extract input text from a corpus and generate, for example, input text “ . . . Lassen county had a population of 34,895. The racial makeup of Lassen county was 25,532 (73.2%) white (U.S. census), 2,834 (8.1%) African American (U.S. census) . . . ”.

The application instruction sequence is one or more programs executed (applied) on the input text and is prepared for each task with respect to a passage to be processed. The program is prepared by a user or the like in advance. Hereinafter, the program may be referred to as an instruction.

For example, the training dataset creation unit 101 creates an application instruction sequence by extracting one or more programs from a set of a plurality of programs (instruction set) such as PASSAGE_SPAN, DIFF, or SUM prepared in advance. Note that, it is assumed that the program include an argument, various variables, or the like.

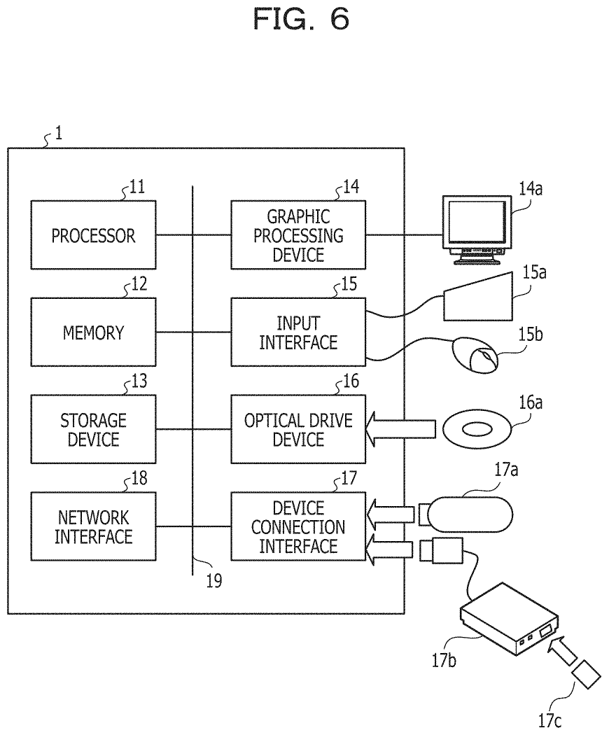

Here, PASSAGE_SPAN is a program for calculating an elapsed time, and DIFF is a program for calculating a difference between values. Furthermore, SUM is a program for calculating a sum of values. An instruction set including the plurality of programs is stored in a predetermined storage region of a storage device 13 (refer to FIG. 6) or the like.

The training dataset creation unit 101 generates an application instruction sequence by randomly selecting any one or more (preferably, two or more) programs from the instruction set. For example, it is assumed that the training dataset creation unit 101 generates an application instruction sequence DIFF (9, SUM (10, 12)). This application instruction sequence DIFF (9, SUM (10, 12)) obtains a sum of “10”-th and “12”-th numbers and subtracts the sum from a “9”-th number.

In a case where a plurality of programs is used as the application instruction sequence, the training dataset creation unit 101 manages an application order of this plurality of programs.

An execution result is an execution result (output sentence) obtained by executing (applying) the application instruction sequence to the input text.

The training dataset creation unit 101 applies the application instruction sequence to the input text. In the example described above, this application instruction sequence DIFF (9, SUM (10, 12)) obtains the sum of the “10”-th and “12”-th numbers and subtracts the sum from the “9”-th number. It may be said that the application instruction sequence represents an estimation process to obtain an application result.

In the input text described above “ . . . Lassen county had a population of 34,895. The racial makeup of Lassen county was 25,532 (73.2%) white (U.S. census), 2,834 (8.1%) African American (U.S. census) . . . ”, the “9”-th number is 34,895, the “10”-th number is 25,532, and the “12”-th number is 2,834.

Therefore, the training dataset creation unit 101 executes the application instruction sequence “DIFF (9, SUM (10, 12))” on the input text described above “ . . . Lassen county had a population of 34,895. The racial makeup of Lassen county was 25,532 (73.2%) white (U.S. census), 2,834 (8.1%) African American (U.S. census) . . . ” so that an application result (output sentence) 6529 {=34895−(25532+2834)} is obtained.

The training dataset creation unit 101 generates a combination of the input text “ . . . Lassen county had a population of 34,895. The racial makeup of Lassen county was 25,532 (73.2%) white (U.S. census), 2,834 (8.1%) African American (U.S. census) . . . ”, the application instruction sequence “DIFF (9, SUM (10, 12))”, and the application result “6529” as the first training data.

The training dataset creation unit 101 creates a plurality of different pieces of first training data (first training dataset) by appropriately changing and combining the input text and the application instruction sequence.

The training dataset creation unit 101 stores the created training dataset, for example, in a predetermined storage region of the storage device 13 illustrated in FIG. 6 or the like.

The second training dataset (training dataset) includes a plurality of pieces of second training data. The second training data is configured by associating passage data, a question sentence for the passage data, with a correct answer for the question sentence.

The passage data is a text sentence written in a natural language. For example, the passage data may be created by randomly extracting a sentence having a length equal to or longer than a predetermined length from a known unlabeled corpus (for example, document database or long text sentence). The question sentence is a text sentence representing a question for the passage data. The correct answer is an answer to the question sentence.

An example of the second training data is given below. The passage data is a text sentence of which the number of words is equal to or more than a predetermined number, for example, as “ . . . Leftwich flipped a 1-yard touchdown pass to Wrighster . . . Leftwich threw a 16-yard touchdown pass to Williams for a 38-0 lead . . . ”. In this example, it is assumed that the sentence include a plurality of numbers.

The question sentence is, for example, “How many yards was the shortest touchdown pass?” and may be related to a numerical value included in passage data. The correct answer may be, for example, “1”.

In this example, it is assumed that an instruction sequence (program) used to obtain a correct answer be “MIN (VALUE (17), VALUE (18))”. The instruction sequence (program) used to obtain a correct answer may be referred to as a correct answer program.

Hereinafter, the second training data may be referred to as NLP data, and in addition, the second training dataset (NLP data) may be referred to as an NLP data group.

The NLP model training unit 103 described later trains the NLP model using the second training dataset (training dataset).

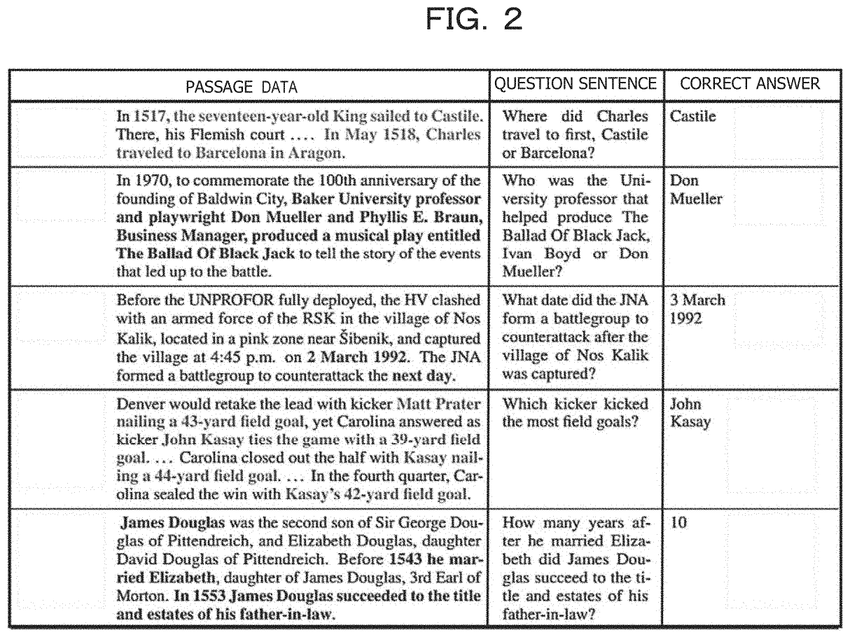

FIG. 2 is a diagram illustrating an example of the NLP data group in the information processing device 1 according to the embodiment. In the example illustrated in FIG. 2, the second training dataset includes passage data, a question sentence, and a correct answer.

The NLP data group (second training dataset) illustrated in FIG. 2 is created by extracting a part of “DROP: A Reading Comprehension Benchmark Requiring Discrete Reasoning Over Paragraphs”. In this way, the second training dataset may be generated using various known documents.

The PS model training unit 102 performs training (machine learning) on a PS model using the training dataset. The PS model is a machine learning model that outputs an instruction sequence (second derivation information) as an inference result for the input dataset (training dataset).

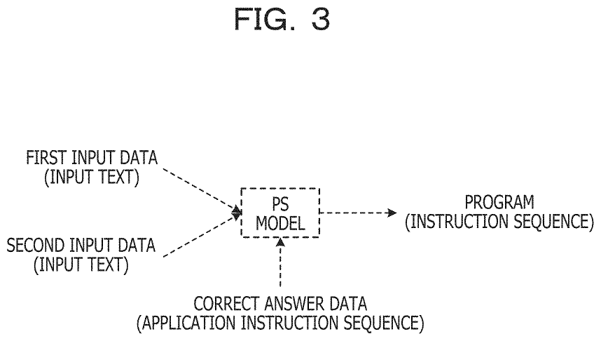

FIG. 3 is a diagram for explaining processing of the PS model training unit 102 of the information processing device 1 according to the embodiment.

The PS model training unit 102 uses the first training dataset to train the PS model. Input text of the first training dataset may be referred to as first input data. Furthermore, an application result of the first training dataset may be referred to as second input data.

The PS model training unit 102 performs training (machine learning) on the PS model by using the input text (first input data) and the execution result (second input data) of the first training dataset as training data and the application instruction sequence of the first training dataset as correct answer data (teacher data).

The PS model training unit 102 inputs the input text (first input data) and the application result (second input data) of the first training dataset to the PS model, which is a machine learning model, as training data and makes the PS model estimate an instruction sequence. Then, the PS model training unit 102 performs reinforcement learning (reinforcement training) so that the instruction sequence estimated by the PS model approaches the application instruction sequence (correct answer data). There is a case where the reinforcement learning (reinforcement training) performed by the PS model training unit 102 so as to make the instruction sequence estimated by the PS model approach the application instruction sequence is referred to as first training.

The PS model training unit 102 may optimize parameters by updating a parameter of tensor decomposition and a parameter of a neural network in a direction for decreasing a loss function that defines an error between the inference result of the machine learning model, with respect to the training data, and correct answer data, for example, using a gradient descent method.

The training of the PS model by the PS model training unit 102 may be expressed, for example, using an objective function (loss function) given in the following formulas (1) and (2).

TRAINING BASED ON SIMILARITY BETWEEN INSTRUCTION SEQUENCES

minΣᵢ∥ [symbol] ᵢ−cmdᵢ∥ (1)

TRAINING USING REINFORCEMENT LEARNING

maxΣᵢ log P(Y=1| [symbol] _{<i}) (2)

[symbol] : ESTIMATED INSTRUCTION SEQUENCE

cmd: APPLICATION INSTRUCTION SEQUENCE

P: CONDITIONED PROBABILITY

Y: WHETHER OR NOT PROGRAM IS CORRECT ANSWER

The PS model trained as described above may estimate a program with high accuracy by performing training by using, as the correct answer data, the application result obtained by applying the application instruction sequence to the input text by the training dataset creation unit 101.

Here, an example is given in which the PS model is trained using a training dataset that combines the above input text “ . . . Lassen county had a population of 34,895. The racial makeup of Lassen county was 25,532 (73.2%) white (U.S. census), 2,834 (8.1%) African American (U.S. census) . . . ”, the application instruction sequence “DIFF (9, SUM (10, 12))”, and the application result “6529”.

It is assumed that the program “SUM (9, DIFF (11, 12))” be output (estimated) by inputting the input text “ . . . Lassen county had a population of 34,895. The racial makeup of Lassen county was 25,532 (73.2%) white (U.S. census), 2,834 (8.1%) African American (U.S. census) . . . ” and the application result “6529” described above to the PS model.

The PS model training unit 102 performs training based on a similarity between instruction sequences on the basis of the output “SUM (9, DIFF (11, 12))” and the correct answer data “DIFF (9, SUM (10, 12))” of the PS model.

The training based on the similarity between the instruction sequences in the above example is given below.

minΣᵢ∥ [symbol] ᵢ−cmdᵢ∥=1+1+1=3

The PS model training unit 102 performs the reinforcement learning so that the estimated instruction sequence approaches the application instruction sequence. A process of the reinforcement learning is given below. In the following example, processes (i) to (iv) are given that estimate an instruction sequence from the beginning and repeatedly performs the reinforcement learning each time when an error in an estimation result is detected.

(i) SUMfirst instruction sentence is wrong

(ii) DIFF (9, DIFFerror is detected in DIFF

(iii) DIFF (9, SUM (11better than last time

(iv) DIFF (9, SUM (10, 12))completed

The NLP model training unit 103 trains the NLP model. The NLP model is a machine learning model that executes processing on document data written in a natural language. The NLP model outputs a program (instruction sequence; first derivation information) as an inference result for the input dataset (second training dataset). Furthermore, by executing the output program with respect to the input question sentence, a corresponding output value is output. This program corresponds to the first derivation information indicating a method for deriving an output value.

The NLP model corresponds to a first model that outputs the output value corresponding to the input question sentence and the program (first derivation information) indicating the method for deriving the output value in response to the input of the passage data and the question sentence.

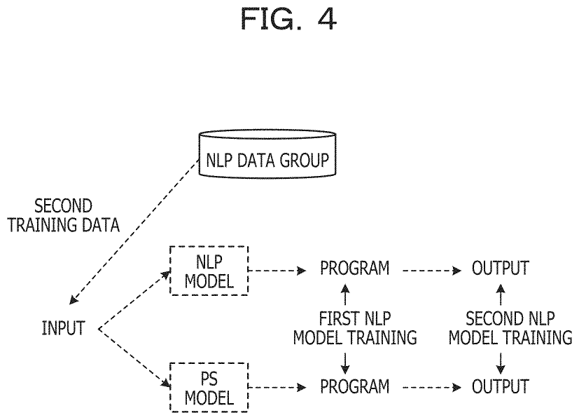

FIG. 4 is a diagram for explaining processing of the NLP model training unit 103 of the information processing device 1 according to the embodiment.

The NLP model training unit 103 uses the second training dataset so as to train the NLP model.

For example, the storage device 13 (refer to FIG. 6) stores a plurality of pieces of second training data (second training dataset) in advance, and the NLP model training unit 103 extracts second training data (NLP data) from the second training dataset (NLP data group) and uses the extracted data to train the NLP model.

The NLP model training unit 103 inputs the same second training data to both of the PS model and the NLP model and obtains each instruction sequence of an inference result.

The NLP model training unit 103 trains the NLP model so that the program estimated by the NLP model is similar to (approach) the program estimated by the PS model. There is a case where the training of the NLP model so that the program estimated by the NLP model is similar to the program estimated by the PS model performed by the NLP model training unit 103 is referred to as first NLP model training. The first NLP model training is training based on a similarity between programs, and trains the NLP model by using the program estimated by the PS model as correct answer data.

The NLP model training unit 103 inputs the input text and the application result of the second training data to the NLP model, which is a machine learning model, as training data and makes the NLP model estimate an instruction sequence.

Furthermore, the NLP model training unit 103 inputs the input text and the application result of the same second training data to the PS model and makes the PS model estimate an instruction sequence.

Then, the NLP model training unit 103 performs the reinforcement learning (reinforcement training) on the NLP model so that the instruction sequence estimated by the NLP model is similar to the instruction sequence estimated by the PS model.

The NLP model training unit 103 performs the first NLP model training on the NLP model by using a method similar to that of the PS model training unit 102 described above. In other words, for example, the NLP model training unit 103 performs training based on the similarity between the instruction sequences using the objective function (loss function) given in the above formulas (1) and (2) on the NLP model.

For example, it is assumed that the instruction sequence estimated by the PS model be “MAX (VALUE (17), VALUE (18))” and the instruction sequence estimated by the NLP model be “MIN (VALUE (17), VALUE (19))”. In the first NLP model training, the NLP model training unit 103 trains the NLP model by assuming that the instruction sequence estimated by the PS model “MAX (VALUE (17), VALUE (18))” as correct answer data.

Furthermore, the NLP model training unit 103 obtains a first output (execution result #1) by executing the program (program #1) estimated by the NLP model on the passage data of the second training data. There is a case where the first output obtained by executing the program estimated by the NLP model on the passage data of the second training data is referred to as an NLP output.

Furthermore, the NLP model training unit 103 obtains a second output (execution result #2) by executing the program (program #2) estimated by the PS model on the passage data of the second training data same as the second training data used to obtain the NLP output. There is a case where the second output obtained by executing the instruction sequence estimated by the PS model on the passage data of the second training data is referred to as a PS output.

Then, the NLP model training unit 103 performs training so as to make the execution result (NLP output) of the program estimated by the NLP model, be similar to (approach) the execution result (PS output) of the program estimated by the PS model.

There is a case where training of the NLP model by the NLP model training unit 103 so as to make the execution result (NLP output) of the program estimated by the NLP model be similar to the execution result (PS output) of the program estimated by the PS model is referred to as second NLP model training. The second NLP model training is training based on a similarity between outputs.

For example, it is assumed that the instruction sequence estimated by the PS model be “MAX (VALUE (17), VALUE (18))” and an output “16” be obtained by applying this instruction sequence to the passage data of the second training dataset. On the other hand, it is assumed that the instruction sequence estimated by the NLP model be “MIN (VALUE (17), VALUE (19))” and an output “1” be obtained by applying this instruction sequence to the passage data of the second training dataset.

In the second NLP model training, the NLP model training unit 103 trains the NLP model so as to reduce a difference between the execution result of the instruction sequence estimated by the NLP model and the execution result of the instruction sequence estimated by the PS model.

The NLP model training unit 103 trains the NLP model with a method according to a target task type. Here, a case where the target task is each of a number problem, a date problem, and a character string problem will be described.

In a case of the number problem, the NLP model training unit 103 sets an absolute value of a difference between a correct answer and a predicted answer as a value of a loss function. In a case described above where the instruction sequence estimated by the PS model is “MAX VALUE (17), VALUE (18))”, an output “16” is obtained, the instruction sequence estimated by the NLP model is “MIN (VALUE (17), VALUE (19))”, and an output “1” is obtained, “16−1=15” is set as the value of the loss function.

In a case of the date problem, the NLP model training unit 103 sets the number of days that is a difference between a correct answer date and a predicted answer date as a value of a loss function. For example, when it is assumed that the correct answer be 1992/03/03 and the predicted answer be 1992/04/02, the value of the loss function is “30”.

In a case of the character string problem, the NLP model training unit 103 sets a Levenshtein distance (editing distance) between the correct answer and the predicted answer as a value of a loss function. Roughly speaking, because it is needed to insert, delete, or replace some words in order to convert the predicted answer into the correct answer, the minimum number of words required to be inserted, deleted, or replaced is assumed as the editing distance. Such an editing distance is set as the value of the loss function.

The NLP model training unit 103 performs training in the second NLP model training such that the value of the loss function described above becomes smaller.

The second training dataset may be, for example, prepared by a user in advance and may be stored in a predetermined storage region of the storage device 13 or the like.

In the example described above, the values of the loss functions of the three types including the number problem, the date problem, and the character string problem largely vary. For example, in a case of the number problem, the correct answer is “16−1=15”. However, in a case where the predicted answer is “16000−1=15999”, the value of the loss function suddenly increases, and this problem effects the training.

Therefore, the NLP model training unit 103 of the information processing device 1 may calculate an average value of absolute values of the loss functions of the respective types of problems at the end of one iteration training and adjust the loss function in a next iteration.

For example, it is assumed that the second training data include 4000 problems and the numbers of the number problem, the date problem, and the character string problem be respectively 2000, 1000, and 1000. When training is started, the NLP model training unit 103 calculates a loss function of each problem. It is assumed that, as a result of reading all the 4000 problems, a total of the absolute values of the loss functions with respect to three types of problems be respectively 15000, 1000, and 3000.

When the average values of these are calculated, the average values are respectively 7.5 (=15000/2000), 1.0 (=1000/1000), and 3.0 (=3000/1000). Here, normalization for setting the sum of the three values to 1.0 is performed, the answers are respectively 0.65 (=7.5/11.5), 0.09 (=1.0/11.5), and 0.26 (=3.0/11.5).

After calculating the loss function in the next iteration, the NLP model training unit 103 solves the problem such that the loss functions vary by dividing the respective values by 0.65, 0.09, and 0.26.

(B) Operation

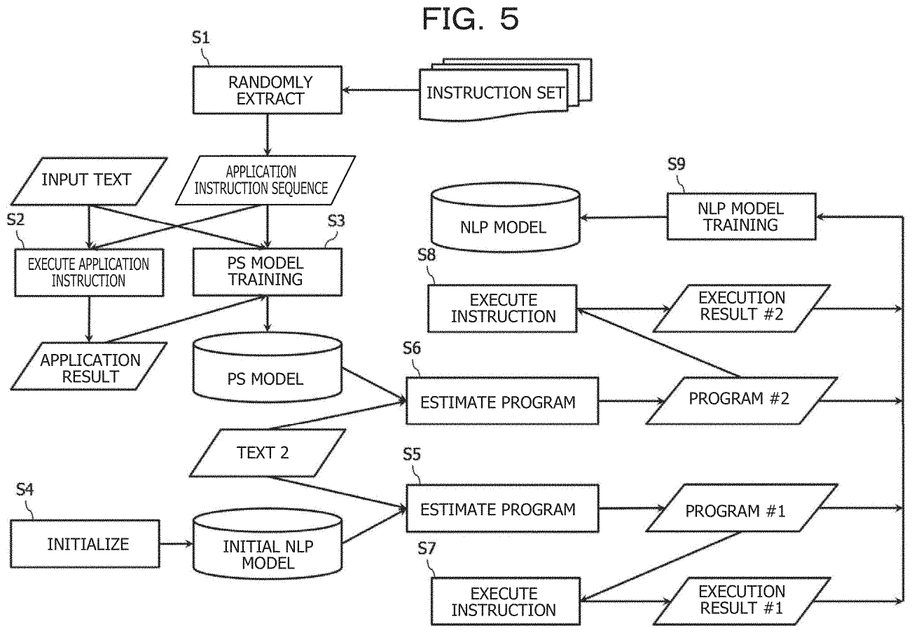

Processing of the information processing device 1 according to the embodiment configured as described above will be described with reference to the flowchart (steps S1 to S9) illustrated in FIG. 5.

Note that, prior to the processing below, it is assumed that the second training dataset be created by the training dataset creation unit 101 and stored in the predetermined storage region of the storage device 13 or the like.

The training dataset creation unit 101 randomly extracts any one or more instructions from an instruction set and creates an application instruction sequence (step S1).

The training dataset creation unit 101 creates input text, for example, by extracting a passage having a predetermined length from a corpus. Then, the application instruction sequence is executed on the input text (step S2), and an application result is acquired. In this way, the training dataset creation unit 101 creates first training data.

The PS model training unit 102 trains a PS model using the first training data. In other words, for example, the PS model training unit 102 trains the PS model using the input text and the application result of the first training data as training data and using the application instruction sequence of the first training data as correct answer data (step S3).

The NLP model training unit 103 initializes an NLP model and creates an initial NLP model (step S4).

The NLP model training unit 103 inputs the input text and the application result of the second training data to the NLP model as training data and makes the NLP model estimate an instruction sequence (program #1) (step S5).

Furthermore, the NLP model training unit 103 inputs the input text and the application result of the same second training data to the PS model and makes the PS model estimate an instruction sequence (program #2) (step S6).

The NLP model training unit 103 obtains an execution result #1 by executing the program #1 estimated by the NLP model on the input text of the second training data (step S7).

Furthermore, the NLP model training unit 103 obtains an execution result #2 by executing the program #2 estimated by the PS model on the input text of the second training data (step S8).

Thereafter, the NLP model training unit 103 performs the first NLP model training for performing the reinforcement learning (reinforcement training) so that the instruction sequence estimated by the NLP model approaches the instruction sequence estimated by the PS model and the second NLP model training for performing the reinforcement learning (reinforcement training) so that an execution result of the instruction sequence estimated by the NLP model approaches an execution result of the instruction sequence estimated by the PS model (step S9). As a result, a trained NLP model is generated.

(C) Effects

In this way, in the information processing device 1 according to the embodiment, the PS model training unit 102 trains the PS model using the first training data including the correct answer data. As a result, a highly accurate PS model may be generated.

Then, the NLP model training unit 103 performs the reinforcement learning (first NLP model training) on the NLP model so that the program estimated by the NLP model is similar to the program estimated by the PS model. As a result, the program output from the NLP model may be improved.

Furthermore, the NLP model training unit 103 trains the NLP model (second NLP model training) so that the execution result (NLP output) of the program estimated by the NLP model is similar to the execution result (PS output) of the program estimated by the PS model. This also makes it possible to improve the program output from the NLP model.

An NLP model suitable for the natural language processing may be generated by training the PS model by the PS model training unit 102, and training the NLP model on the basis of the trained PS model by the NLP model training unit 103.

Because the program (instruction sequence) generated by the NLP model represents an inference process of the NLP model, a user may easily understand the inference process of the NLP model by referring to this program.

The training dataset creation unit 101 randomly extracts a passage having a length equal to or longer than a predetermined length from a known unlabeled corpus so as to create the input text of the first training dataset. Furthermore, the training dataset creation unit 101 acquires the execution result by executing the application instruction sequence on the input text.

Then, the PS model training unit 102 uses the input text (first input data) and the execution result (second input data) of the first training data as training data and uses the application instruction sequence of the first training data as correct answer data (teacher data). In this way, the training of the PS model may be achieved without preparing a corpus of correct answer programs, and it is possible to reduce cost.

When the NLP model is trained, the NLP model training unit 103 performs the reinforcement learning (first NLP model training) on the NLP model so that the program estimated by the NLP model is similar to the program estimated by the PS model. Furthermore, the NLP model training unit 103 trains the NLP model (second NLP model training) so that the execution result (NLP output) of the program estimated by the NLP model is similar to the execution result (PS output) of the program estimated by the PS model.

In other words, for example, the training of the NLP model may be also achieved without preparing a corpus of correct answer programs, and it is possible to reduce the cost.

(D) Others

FIG. 6 is a diagram illustrating a hardware configuration of the information processing device 1 according to the embodiment.

The information processing device 1 is a computer and includes, for example, a processor 11, a memory 12, the storage device 13, a graphic processing device 14, an input interface 15, an optical drive device 16, a device connection interface 17, and a network interface 18 as components. These components 11 to 18 are configured to be communicable with each other via a bus 19.

The processor (processing unit) 11 controls the entire information processing device 1. The processor 11 may be a multiprocessor. The processor 11 may be, for example, any one of a central processing unit (CPU), a micro processing unit (MPU), a digital signal processor (DSP), an application specific integrated circuit (ASIC), a programmable logic device (PLD), and a field programmable gate array (FPGA). Furthermore, the processor 11 may be a combination of two or more types of elements of the CPU, MPU, DSP, ASIC, PLD, and FPGA.

Then, by executing a control program (machine learning program, not illustrated) by the processor 11, functions as the training dataset creation unit 101, the PS model training unit 102, and the NLP model training unit 103 illustrated in FIG. 1 are implemented.

Note that the information processing device 1 implements the functions as the training dataset creation unit 101, the PS model training unit 102, and the NLP model training unit 103, for example, by executing the program (machine learning program, OS program) recorded in a computer-readable non-transitory recording medium.

A program in which processing content to be executed by the information processing device 1 is described may be recorded in various recording media. For example, the program to be executed by the information processing device 1 may be stored in the storage device 13. The processor 11 loads at least some of the programs in the storage device 13 on the memory 12 and executes the loaded programs.

Furthermore, the program to be executed by the information processing device 1 (processor 11) may be recorded on a non-transitory portable recording medium such as an optical disk 16a, a memory device 17a, or a memory card 17c. The program stored in the portable recording medium may be executed after being installed in the storage device 13, for example, by control from the processor 11. Furthermore, the processor 11 may directly read the program from the portable recording medium and execute the program.

The memory 12 is a storage memory including a read only memory (ROM) and a random access memory (RAM). The RAM of the memory 12 is used as a main storage device of the information processing device 1. The RAM temporarily stores at least some of the programs to be executed by the processor 11. Furthermore, the memory 12 stores various types of data needed for the processing by the processor 11.

The storage device 13 is a storage device such as a hard disk drive (HDD), a solid state drive (SSD), or a storage class memory (SCM), and stores various types of data. The storage device 13 is used as an auxiliary storage device of the information processing device 1.

The storage device 13 stores an OS program, a control program, and various types of data. The control program includes a machine learning program.

Note that a semiconductor storage device such as an SCM or a flash memory may be used as the auxiliary storage device. Furthermore, redundant arrays of inexpensive disks (RAID) may be configured by using a plurality of storage devices 13.

The storage device 13 may store the NLP data group and the first training dataset and the second training dataset created by the training dataset creation unit 101. Furthermore, the data or the like generated according to the processing by the PS model training unit 102 and the NLP model training unit 103 may be stored. For example, the data included in the PS model and the data included in the NLP model may be stored.

The graphic processing device 14 is connected to a monitor 14a. The graphic processing device 14 displays an image on a screen of the monitor 14a in accordance with an instruction from the processor 11. Examples of the monitor 14a include a display device using a cathode ray tube (CRT), a liquid crystal display device, and the like.

The input interface 15 is connected to a keyboard 15a and a mouse 15b. The input interface 15 transmits signals sent from the keyboard 15a and the mouse 15b to the processor 11. Note that the mouse 15b is an example of a pointing device, and another pointing device may also be used. Examples of the another pointing device include a touch panel, a tablet, a touch pad, a track ball, or the like.

The optical drive device 16 reads data recorded on the optical disk 16a by using laser light or the like. The optical disk 16a is a non-transitory portable recording medium having data recorded in a readable manner by reflection of light. Examples of the optical disk 16a include a digital versatile disc (DVD), a DVD-RAM, a compact disc read only memory (CD-ROM), a CD-recordable (R)/rewritable (RW), or the like.

The device connection interface 17 is a communication interface for connecting peripheral devices to the information processing device 1. For example, the device connection interface 17 may be connected to the memory device 17a and a memory reader/writer 17b. The memory device 17a is a non-transitory recording medium equipped with a communication function with the device connection interface 17 and is, for example, a universal serial bus (USB) memory. The memory reader/writer 17b writes data to the memory card 17c or reads data from the memory card 17c. The memory card 17c is a card-type non-transitory recording medium.

The network interface 18 is connected to the network. The network interface 18 transmits and receives data via the network. Other information processing devices, communication devices, and the like may be connected to the network. For example, connection with a corpus used to generate the first training dataset and the second training dataset or the like may be performed via the network interface 18, and the connection may be appropriately modified and performed.

Then, the disclosed technique is not limited to the above-described embodiment, and various modifications may be made and implemented without departing from the spirit of the present embodiment. Each configuration and each processing of the present embodiment may be selected or omitted as needed or may be appropriately combined.

For example, in the embodiment described above, an example has been given in which an English sentence is used as the text sentence. However, the embodiment is not limited to this, and may be applied to languages other than English, and may be variously modified and implemented.

Furthermore, in the embodiment described above, an example has been given in which the program such as PASSAGE_SPAN, DIFF, or SUM is used as the application instruction sequence. However, the embodiment is not limited to this. For example, as the application instruction sequence, a Python (registered trademark) program such as max.py, count.py, or extract_number.py may be used, and the embodiment may be appropriately modified and implemented.

Here, for example, extract_number.py is a program for extracting a number. Furthermore, max.py is a program for selecting the maximum number from a set of numbers. These programs may include information such as arguments.

Furthermore, the present embodiment may be carried out and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program that causes a computer to execute a process, the process comprising:
acquiring a training dataset that includes a plurality of pieces of training data in which passage data, a question sentence related to the passage data, and an output value that is an answer to the question sentence are associated one another; and
training a first model using the training dataset so that first derivation information output from the first model approaches to second derivation information output from a second model, the first model being configured to output a first output value and the first derivation information when first passage data and a first question sentence are input, the first output value corresponding to the first question sentence, the first derivation information indicating a method of deriving the first output value from first information included in the first passage data, the second model being configured to output the second derivation information when the first passage data and a second output value are input, the second derivation information indicating a method of deriving the second output value from the first information.

2. The non-transitory computer-readable recording medium according to claim 1, the process further comprising:
prior to the training of the first model, training the second model by inputting training data and an instruction sequence as derivation information, the training data including training passage data and an output value that is derived by executing the instruction sequence on the training passage data.

3. The non-transitory computer-readable recording medium according to claim 1, the process further comprising:
training the first model so that an output value that is derived from the first information in accordance with the first derivation information approaches to an output value that is derived from the first information in accordance with the second derivation information.

4. An information processing device, comprising:
a memory; and
a processor coupled to the memory and the processor configured to:
acquire a training dataset that includes a plurality of pieces of training data in which passage data, a question sentence related to the passage data, and an output value that is an answer to the question sentence are associated one another; and
train a first model using the training dataset so that first derivation information output from the first model approaches to second derivation information output from a second model, the first model being configured to output a first output value and the first derivation information when first passage data and a first question sentence are input, the first output value corresponding to the first question sentence, the first derivation information indicating a method of deriving the first output value from first information included in the first passage data, the second model being configured to output the second derivation information when the first passage data and a second output value are input, the second derivation information indicating a method of deriving the second output value from the first information.

5. The information processing device according to claim 4, wherein
the processor is further configured to:
prior to the training of the first model, train the second model by inputting training data and an instruction sequence as derivation information, the training data including training passage data and an output value that is derived by executing the instruction sequence on the training passage data.

6. The information processing device according to claim 4, wherein
the processor is further configured to:
train the first model so that an output value that is derived from the first information in accordance with the first derivation information approaches to an output value that is derived from the first information in accordance with the second derivation information.

7. A method of machine learning, the method comprising:
acquiring, by a computer, a training dataset that includes a plurality of pieces of training data in which passage data, a question sentence related to the passage data, and an output value that is an answer to the question sentence are associated one another; and
training a first model using the training dataset so that first derivation information output from the first model approaches to second derivation information output from a second model, the first model being configured to output a first output value and the first derivation information when first passage data and a first question sentence are input, the first output value corresponding to the first question sentence, the first derivation information indicating a method of deriving the first output value from first information included in the first passage data, the second model being configured to output the second derivation information when the first passage data and a second output value are input, the second derivation information indicating a method of deriving the second output value from the first information.

8. The method according to claim 7, further comprising:
prior to the training of the first model, training the second model by inputting training data and an instruction sequence as derivation information, the training data including training passage data and an output value that is derived by executing the instruction sequence on the training passage data.

9. The method according to claim 7, further comprising:
training the first model so that an output value that is derived from the first information in accordance with the first derivation information approaches to an output value that is derived from the first information in accordance with the second derivation information.
